(19) United States
(12) Patent Application Publication
(10) Pub. No.: US 2006/0249322 A1
(43) Pub. Date: Nov. 9, 2006

(54) Handiwheeler

(76) Inventors: Sole Sawa Maki, Charlotte, NC (US); Brian Willie Leake, Charlotte, NC (US)

Correspondence Address: SOLE-MAKI;APT. 705, 1511 WILLOW PARK DR., CHARLOTTE, NC, 28205, US

(21) Appl. No.: 11/088,097

(22) Filed: May 9, 2005

(51) Int. Cl. B62D 61/06; B60K 26/00

(52) U.S. Cl. 180/210; 180/215; 180/333

(57) ABSTRACT

The Handiwheeler is a modified motorcycle, which allows individuals with physical limitation to safely operate and enjoy the freedom of a cycle style vehicle. Wide seat dual back wheel of the device offer stability to the Handiwheeler and prevent tipping. Safety side rails contain a person's legs inside the chair and cab area of the bike. Available in single and dual passenger modeles, the cab area encloses a person safely and provides a seat belt to further secure a user. Adjustable headrests further add to the safety and comfort features of the Handiwheeler. All operational controls to the bike are located on the handgrips and steering column. Brake, clutch, hand shifter, and gas control are all positioned onto, or near, the handgrips of the Handiwheeler. These controls allow an individual to completely operate the Handiwheeler without the use of one's legs. For an individual who no longer has the use of one's legs, the Handiwheeler is the ideal product. A user may simply transfer his/herself from a wheelchair to the seat of the Handiwheeler. A user's legs are securely contained within the cab area of the bike, and the seat belt is utilized to prevent unwanted movement of an individual's torso during operation of the bike. Once secured in the vehicle's seat, a user may commence to operation of the Handiwheeler. All controls to the bike are located on near the handgrips of the steering column. Elimination of all foot controls makes the Handiwheeler the perfect product for paralyzed individuals looking for independent transportation.

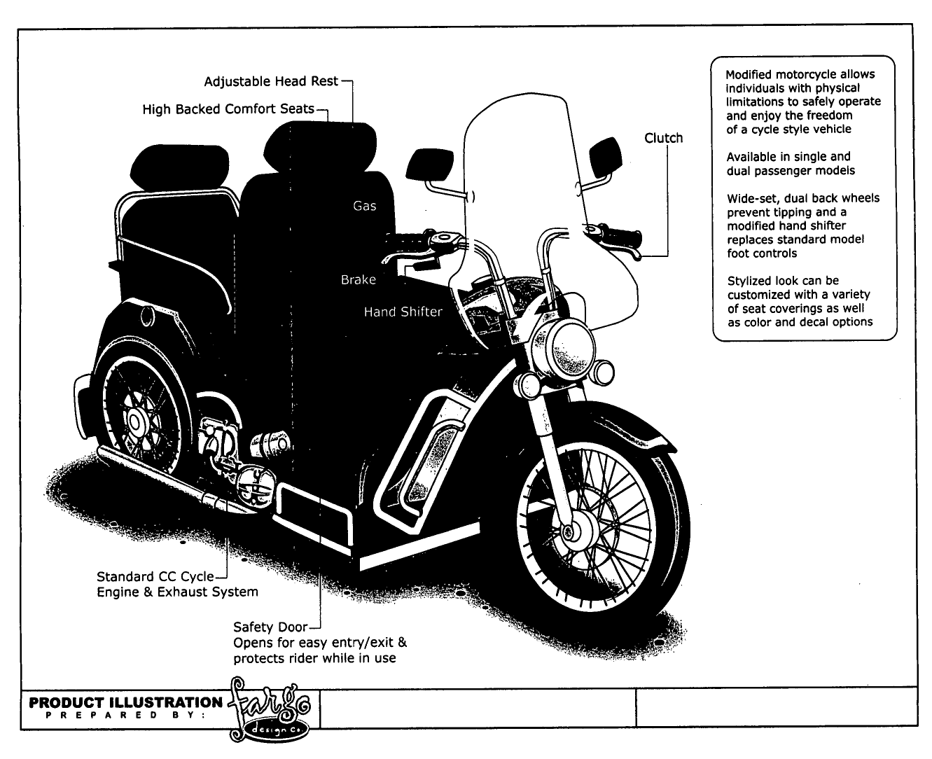

### 0001. INVENTION FUNCTION

The Handiwheeler provides individuals with physical limitation a cycle style vehicle that is fully operational by the use of one's arms.

### 0002. SPECIFIC UNIQUE FUNCTION OR PROPERTY OF INVENTION

The Handiwheeler is a modified motorcycle allowing handicapped individuals to safely operate and enjoy the freedom of a cycle style vehicle by providing wide seat, dual back wheels that prevent tipping and a modified hand shifter to operate the Handiwheeler fully by the use of a use's arms.

### 0003. INVENTOR'S SUGGESTED MATERIAL AND COMPONENTS

The Handiwheeler is manufactured in various types of metal alloy, electrical wiring and components, and numerous other materials commonly utilized in the production of a motorcycle.

### 0004. MECHANICAL DESCRIPTION

The Handiwheeler is a modified motorcycle, which allows individuals with physical limitations to safely operate and enjoy the freedom of a cycle style vehicle. Wide seat dual back wheel (A) of the device offer stability to the Handiwheeler and prevent tipping. Safety side rails (B) contain a person's legs inside the chair and cab area (C) of the bike. Available in single and dual passenger models, the cab area (C) encloses a person safely and provides a seat belt to further secure a user. Adjustable headrests (D) further add to the safety and comfort features of the Handiwheeler. All operational controls to the bike are located on the handgrips and steering column (E). brake, clutch, hand shifter, and gas control are all positioned onto, or near, the handgrips (E) of the Handiwheeler these controls allow an individual to completely operate the Handiwheeler without the use of one's legs.

### 0005. USAGE

For an individual who no longer has the use of one's legs, the Handiwheeler is the ideal product. A user may simply transfer his/herself from a wheelchair to the seat of the Handiwheeler A user's legs are securely contained within the cab area of the bike, and the seat belt is utilized to prevent unwanted movement of an individual's torso during operation of the bike. Once secured in the vehicle's seat, a user may commence to operation of the Handiwheeler. All controls to the bike are located on or near the handgrips of the steering column. Elimination of all foot controls makes the Handiwheeler the perfect product for paralyzed individuals looking for independent transportation.

1. I claim my invention Handiwheeler, provide individuals with physical limitation a cycle style vehicle that is fully operational by the use of one's arms.

2. I claim my invention Handiwheeler, is a modified motorcycle which allow handicapped individuals to safely operate and enjoy the freedom of a cycle style vehicle by providing wide set, dual back wheels that prevent tipping and a modified hand shifter to operate the Handiwheeler fully by the use of a user's arms.

3. I claim my invention Handiwheeler, would mainly be utilized by handicapped people for transportation, use of the Handiwheeler allows those with physical disabilities to be more independent because they no longer need to rely on others for their transportation.
